(19) United States
(12) Patent Application Publication
(10) Pub. No.: US 2008/0101494 A1
(43) Pub. Date: May 1, 2008

(54) System and method for generating MIMO signals

(75) Inventors: Jayesh H. Kotecha, Austin, TX (US); Taeyoon Kim, Austin, TX (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR, INC.

(21) Appl. No.: 11/589,874

(22) Filed: Oct. 31, 2006

(51) Int. Cl. H04L 1/02

(52) U.S. Cl. 375/267

(57) ABSTRACT

A method (400) is provided for processing signals in a multiple-input/multiple-output system (200). The method comprises: receiving a stream of B data bits (410); modulating the B data bits into J data symbols chosen from a set symbol constellation (420); converting the J data symbols into L preprecoded symbols based on a preprecoder function (430); encoding the L preprecoded symbols into M symbol streams, each having K encoded symbols, based on a space-time code (440); and providing the M symbol streams on one or more output lines. In this method, B, J, K, L, and M are integers.

### FIELD OF THE INVENTION

The present invention relates in general to a system and method for generating multiple input/multiple output (MIMO) signals. In particular it relates to a system and method for applying a preprecoder to the MIMO signals before they are transmitted to account for properties of the wireless channel and thereby improve signal performance.

### BACKGROUND OF THE INVENTION

When transmitting data across a medium, wired or wireless, it is generally desirable to increase the amount of data that is sent at a given time to allow for a higher data rate for the underlying system. In a single-antenna, wireless transmission system, typically a single stream of data is transmitted.

However, using a multiple antenna system, multiple streams can be transmitted and received using the same time and frequency resources, and correspondingly more information can be sent over the available bandwidth. As shown below, it is possible to use multiple antenna systems and multi-input, multi-output (MIMO) systems interchangeably. In MIMO systems, there are a number of possible signal paths through the transmission medium equal to the number of transmitting antennas multiplied by the number of receiving antennas.

FIG. 1 is a block diagram illustrating a conventional MIMO transmitter/receiver pair. As shown in FIG. 1, a transmitter includes a MIMO modulator 110, an antenna 130, and an antenna 135, while a receiver includes a MIMO demodulator 120, an antenna 140, and an antenna 145. The MIMO modulator receives transmit signals and modulates them for transmission over antenna 130 and antenna 135. These signals are received at antenna 140 and antenna 145, and the received signals are demodulated at the MIMO demodulator 120 to extract a received signal.

Because there are two transmitting antennas 130 and 135, and two receiving antennas 140 and 145, there are four possible signal paths through the transmission channel. There is a path from the antenna 130 to the antenna 140; a path from the antenna 130 to the antenna 145; a path from the antenna 135 to the antenna 140; and a path from the antenna 135 to the antenna 145. MIMO systems with a larger number of transmitting or receiving antennas would have a correspondingly larger number of possible signal paths.

The MIMO receiver antennas 140 and 145 thus each receive a copy of each signal transmitted from all of the transmitting antennas. But each copy of a transmitted signal from a given transmitter antenna passes through a different portion of the transmission channel, and is multiplied by a different channel coefficient to determine what signal the receiver antennas receive.

In particular, h₁₁ represents a channel portion from a transmitter 130 antenna to a receiver antenna 140; h₂₁ represents a channel portion from the transmitter antenna 130 to a receiver antenna 145; h₁₂ represents a channel portion from the transmitter antenna 135 to the receiver antenna 140; and h₂₂ represents a channel portion from the transmitter antenna 135 to the receiver antenna 145. A general representation H of the transmission channel, as it pertains to the MIMO transmitter and receiver, can then be written as a matrix of the individual channel coefficients h₁₁, h₁₂, h₂₁, and h₂₂. In other words,

$$H = [ \begin{matrix}{h}_{11} & {h}_{12} \\ {h}_{21} & {h}_{22}\end{matrix} ] . \qquad ( 1 )$$

More generically H can be written as an (N×M) matrix where M is the number of transmit antennas and N is the number of receiver antennas.

A transmitter with a single antenna can only modulate data in time. In other words, it can only send different portions of data through the antenna at different times. A MIMO transmitter, in contrast, can modulate the data in both space and time. In other words, in addition to sending different portions of data at different times, the MIMO transmitter can also send different portions of data over the different antennas as the same time. This allows a MIMO transmitter to send a larger amount of data in the same time period as compared to a single antenna system.

The MIMO receiver receives the various signals at its receiver antennas from across the various individual channel portions, and its MIMO demodulator 120 uses MIMO signal processing to extract the different portions of data that were sent.

In addition, rather than increasing data rate, a MIMO system could also be used to increase the range of the transmission system by increasing the level of redundancy, error correction, or the like.

However, because a wireless channel H is a fading channel (i.e., signals passing through it reflect off of objects and take multiple paths to the receivers), each transmitted signal experiences fading, causing a reconstructed signal at the MIMO receiver to itself experience fading. This fading can require an increased cost and complexity for the MIMO receiver to properly process the faded signal, and increased time for such back end processing.

One way to limit the effect of fading on a received MIMO signal is to apply a precoder to the MIMO signals right before transmission that will account for the degree of fading the MIMO signals will experience. The precoder is a matrix of correction values that account for a current condition of the channel H, and which can be either determined by the transmitter, or supplied to the transmitter by an outside source. Such a precoder matrix can be difficult to calculate in many circumstances, however, which can limit the effectiveness of the precoder.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram illustrating a conventional MIMO transmitter/receiver pair;

FIG. 2 is a block diagram illustrating a MIMO transmitter/receiver pair according to a disclosed embodiment;

FIG. 3 is a block diagram of an comparable circuit of the circuit of FIG. 2;

FIG. 4 is a flow chart showing a method of operating a MIMO transmitter according to a disclosed embodiment.

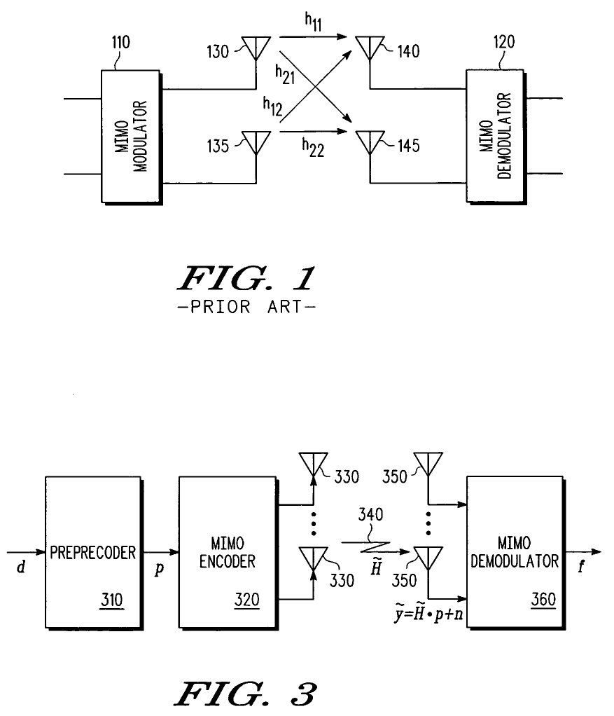

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best implemented in integrated circuits (ICs), and in particular through the use of circuits involving CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs, if any, will be limited to the essentials with respect to the principles and concepts used by the exemplary embodiments.

MIMO System with Preprecoding

Another way to limit the effect of fading on a received MIMO signal is to apply some sort of correctional coding at an earlier portion of a signal path in a transmitter than a precoder. As noted above, in a space-time coded MIMO system, preceding takes place after the symbols to be transmitted are encoded into a space-time code. But a preprecoding process is performed on the symbols before they are encoded into a space-time code. As with the precoder, the preprecoder can be selected to account for a current condition of the channel H, and can be either determined by the transmitter, or supplied to the transmitter by an outside source.

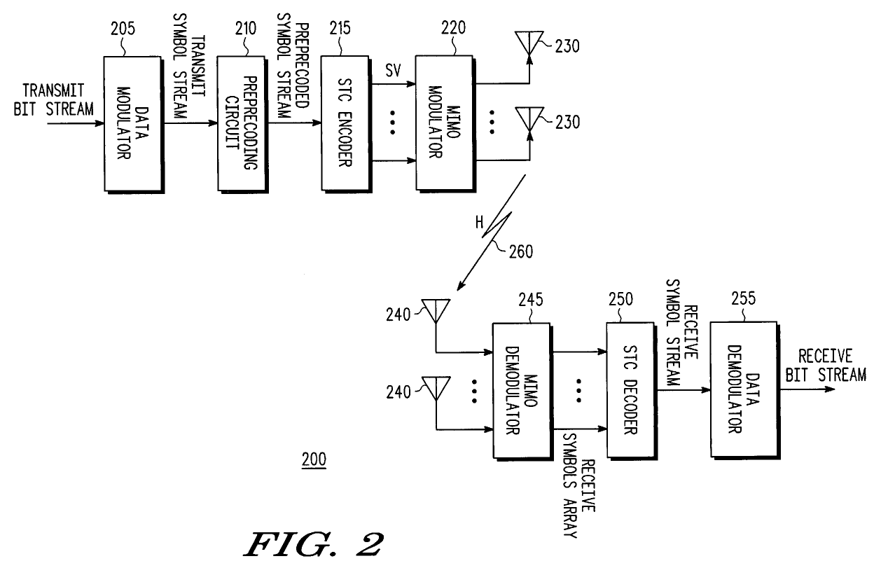

FIG. 2 is a block diagram illustrating a MIMO transmitter/receiver pair according to a disclosed embodiment. As shown in FIG. 2, the MIMO transmitter/receiver pair 200 includes a data modulator 205, a preprecoding circuit 210, a space-time code (STC) encoder 215, a MIMO modulator 220, a plurality of MIMO transmitter antennas 230, a plurality of MIMO receiver antennas 240, a MIMO demodulator 245, an STC decoder 250, and a channel decoder/demodulation circuit 255. The data modulator 205, preceding circuit 210, STC encoder 215, MIMO modulator 220, and plurality of MIMO transmitter antennas 230 form a MIMO transmitter; and the plurality of MIMO receiver antennas 240, MIMO demodulator 245, STC decoder 250, and channel decoder/demodulation circuit 255 form a MIMO receiver.

The data modulator 205 receives a set of transmit bits (i.e., transmit data) and modulates those bits into a stream of data symbols for transmission. In the disclosed embodiment the data symbol stream is a single stream of data. In alternate embodiments, the data modulator could split the data symbols stream into multiple parallel data streams. Such data streams could originate from a single data source or from multiple data sources.

The data modulator 205 can use any desired modulation scheme to modulate the data bits into symbols. In one embodiment, the data modulator 205 can use a binary phase shift key (BPSK) scheme to modulate a single bit onto each symbol. In another embodiment, the data modulator 205 can use a quadrature phase shift key (QPSK) modulation scheme to modulate two bits onto each symbol. More generally, the data modulator 205 can use a size N quadrature amplitude modulation (N-QAM) scheme (such as a 8-QAM, 16-QAM, or 64-QAM) to encode B bits onto each symbol (where N=2^{B}). The exact number of symbols mapped onto a given STC can vary among embodiments, however.

Although the data modulator 205 outputs a steady stream of data symbols, later portions of the system 200 will operate on discrete portions of this symbol stream. In particular, the system will operate on groups of J symbols (where J is an integer). As noted above, these data symbols could come from a single data source or multiple data sources, up to J data sources.

The system will therefore effectively operate as if the data modulator 205 was outputting a stream of data symbol vectors d, each of which contains J symbols (i.e., d is a vector with a dimension of (J×1). In one exemplary embodiment the data symbol vector d is of length two (i.e., J=4), such that:

$$d = [ \begin{matrix}{d}_{1} \\ {d}_{2} \\ {d}_{3} \\ {d}_{4}\end{matrix} ] \qquad ( 2 )$$

However, in alternate embodiments J could vary in length, with the size of d changing accordingly.

The preprecoding circuit 210 multiplies the received data symbol stream by a (J×J) square preprecoding matrix V (also called a preprecoder). In the exemplary embodiment in which the data symbol vector d is of length four, V is a (4×4) matrix:

$$V = [ \begin{matrix}{v}_{11} & {v}_{12} & {v}_{13} & {v}_{14} \\ {v}_{21} & {v}_{22} & {v}_{23} & {v}_{24} \\ {v}_{31} & {v}_{31} & {v}_{33} & {v}_{34} \\ {v}_{41} & {v}_{41} & {v}_{43} & {v}_{44}\end{matrix} ] \qquad ( 3 )$$

This has the effect of multiplying each data symbol vector d by the preprecoder V, to obtain a preprecoded symbol vector p, also of length J.

$$\begin{matrix}p = V \cdot d , & ( 4 ) \\ [ \begin{matrix}{p}_{1} \\ {p}_{2} \\ {p}_{3} \\ {p}_{4}\end{matrix} ] = [ \begin{matrix}{v}_{11} & {v}_{12} & {v}_{13} & {v}_{14} \\ {v}_{21} & {v}_{22} & {v}_{23} & {v}_{24} \\ {v}_{31} & {v}_{31} & {v}_{33} & {v}_{34} \\ {v}_{41} & {v}_{41} & {v}_{43} & {v}_{44}\end{matrix} ] \cdot [ \begin{matrix}{d}_{1} \\ {d}_{2} \\ {d}_{3} \\ {d}_{4}\end{matrix} ] , & ( 5 )\end{matrix}$$

or in other words:

p₁=v₁₁·d₁+v₁₂·d₂+v₁₃·d₃+v₁₄·d₄, (6)

p₂=v₂₁·d₁+v₂₂·d₂+v₂₃·d₃+v₂₄·d₄, (7)

p₃=v₃₁·d₁+v₃₂·d₂+v₃₃·d₃+v₃₄·d₄, and (8)

p₄=v₄₁·d₁+v₄₂·d₂+v₄₃·d₃+v₄₄·d₄. (9)

The values in the preprecoding matrix V are chosen to modify the symbols in the data symbol vector d in a desired manner to generate the preprecoded symbol vector p. In the exemplary embodiment, the values of v₁₁, v₁₂, v₁₃, v₁₄, v₂₁, v₂₂, v₂₃, v₂₄, v₃₁, v₃₂, v₃₃, v₃₄, v₄₁, v₄₂, v₄₃, and v₄₄ are chosen to convert the symbols d₁, d₂, d₃, and d₄ to the symbols p₁, p₂, p₃, and p₄, respectively, according to equations (6)-(9).

In the simple case where a preprecoding circuit 210 is not used, the preprecoding matrix V can simply be replaced in these equations with a unity matrix, meaning that p₁, p₂, p₃, and p₄ are equal to d₁, d₂, d₃, and d₄, respectively.

In the above disclosed embodiment, the preprecoder is a linear matrix operation on the data array d. In alternate embodiments, however, the preprecoder may be a non-linear operation such that the data vector is a function of the preprecoder and the data vector, which can be expressed as

p=V(d). (10)

Although in the disclosed embodiments p is an array of length J, in alternate embodiments p may have length greater than or less than J, but always greater than zero.

The exact way by which the preprecoding circuit 210 accomplishes this multiplication depends upon how the data symbol stream d is supplied to the preprecoding circuit 210.

The STC encoder 215 takes the preprecoded symbol stream p and maps it into an appropriate two-dimensional space time code (STC) (i.e., a matrix of STC values). A space-time code (STC) uses the dimensions of space and time to encode multiple data symbols. Space is employed through the use of an array of multiple antennas; time is used by having each antenna in the array send a series of transmitted symbols in succession.

The STC encoder 215 accomplishes this mapping function by using the preprecoded symbol stream p to populate the STC S according to a particular STC encoding scheme. This scheme can involve using elements of the preprecoded symbol stream p directly as elements of the STC matrix S, or can involve performing linear or nonlinear operations on elements of the preprecoded symbol stream p to generate elements of the STC matrix S.

In one embodiment, the preprecoded symbol stream p has a length equal to the total number of elements in the STC S, and each element in the STC S is based on a different element in the preprecoded symbol stream p. In another embodiment, the preprecoded symbol stream p is actually a single symbol that is used to generate every element in the STC S. In other embodiments the preprecoded symbol stream p has a length between 1 and the total number of elements in the STC S, and the STC S is populated with some combination of the elements in the of the elements of the preprecoded symbol stream p.

The number of rows in the STC matrix S is equal to the number of transmit antennas 230 used, while the number of columns in the STC matrix S is equal to the length of transmission by each antenna 230 used to represent the preprecoded symbol stream p. In one disclosed embodiment, four transmit antennas 230 are used, and each antenna 230 transmits signals representing two symbols for each STC. Thus, the STC matrix S in this embodiment is a (4×2) matrix.

If M transmit antennas 230 are used, and each antenna transmits K symbols to represent the J data symbols in the preprecoded symbol stream p, then the STC matrix S output from the STC encoder 215 is an (M×K) matrix. Consider an exemplary embodiment in which four transmitter antennas 230 are used (i.e., M=4), and each transmitter antenna 230 transmits two data symbols to represent a preprecoded symbol stream p (i.e., K=2). In this case, the STC matrix S is a (4×2) matrix having eight elements

At a first time interval, a first STC output line will provide a symbol s_{1A}, a second STC output line will provide a symbol s_{2A}, a third output line will provide a symbol s_{3A}, and a fourth output line will provide a symbol s_{4A}. The resulting set of output symbols could be written as a size four symbol array s_{A}, in which:

$${s}_{A} = [ \begin{matrix}{s}_{1 A} \\ {s}_{2 A} \\ {s}_{3 A} \\ {s}_{4 A}\end{matrix} ] . \qquad ( 11 )$$

Likewise at second time interval, the first STC output line will provide a symbol s_{1B}, and the second STC output line will provide a symbol s_{2B}, a third output line will provide a symbol s_{3B}, and a fourth output line will provide a symbol s_{4B}. The resulting transmission could be written as a size four symbol array s_{B}, in which:

$${s}_{B} = [ \begin{matrix}{s}_{1 B} \\ {s}_{2 B} \\ {s}_{3 B} \\ {s}_{4 B}\end{matrix} ] . \qquad ( 12 )$$

Thus, in this exemplary embodiment the J data symbols in the preprecoded symbol stream p are represented by the (4×2) STC matrix S, where:

$$S = [ \begin{matrix}{s}_{1 A} & {s}_{1 B} \\ {s}_{2 A} & {s}_{2 B} \\ {s}_{3 A} & {s}_{3 B} \\ {s}_{4 A} & {s}_{4 B}\end{matrix} ] . \qquad ( 13 )$$

In one particular embodiment, each STC encodes four symbols (i.e., J=4). In this embodiment the elements of the STC matrix S are populated as follows:

s_{1A}=p₁, (14)

s_{2A}=p₂, (15)

s_{3A}=p₃, (16)

s_{4A}=p₄, (17)

s_{1B}=−s_{2A}*, (18)

s_{2B}=s_{1A}*. (19)

s_{3B}=−s_{4A}*, and (20)

s_{4B}=s_{3A}*. (21)

In this way, each STC encodes four preprecoded data symbols into a (4×2) STC matrix S as follows:

$$S = [ \begin{matrix}{s}_{1 A} & - {s}_{2 A}^{*} \\ {s}_{2 A} & {s}_{1 A}^{*} \\ {s}_{3 A} & - {s}_{4 A}^{*} \\ {s}_{4 A} & {s}_{3 A}^{*}\end{matrix} ] \qquad ( 22 )$$

Alternate embodiments can use other encoding schemes that use different values for s_{1A}, s_{1B}, s_{1C}, s_{1D}, s_{2A}, s_{2B}, s_{2C}, and s_{2D} to fill a (4×2) STC matrix S. In addition, alternate embodiments can encode a different number of symbols into the STC matrix S (i.e., J may have other values than 4 in the disclosed embodiment), up to the total number of elements in the STC matrix S. For example, in some embodiments only a single symbol can be encoded into the STC matrix S; in other embodiments a larger number of symbols could be encoded into the STC matrix S (up to eight in the disclosed embodiment).

In the disclosed embodiment, the STC encoder 215 has M output lines (i.e., a number of physical output lines equal to the number of transmit antennas 230), each of which output lines generates a symbol stream of K sequential symbols for each received preprecoded symbol stream p. In this way the STC encoder 215 can pass one iteration of the STC matrix S for each instance of the preprecoded symbol stream p. However, the STC encoder 210 could be modified in alternate embodiments to have more or fewer physical output lines. For example, the STC encoder 215 could have a single output line that serially passes all the elements of the STC matrix S for each received preprecoded symbol stream p. Alternatively, the STC encoder 215 could have M times K output lines that pass all of the elements of the STC matrix S at once. Other variations are possible.

The MIMO modulator 220 takes the series of symbol arrays that make up the STC matrix S (s_{A} and s_{B} in the disclosed embodiment), and converts the received symbols into appropriate waveforms for transmission. Each possible symbol in the available symbol constellation corresponds to a unique waveform for transmission. The details of these waveforms will depend upon the kind of modulation used (e.g., QPSK, N-QAM, etc.).

The plurality of MIMO transmitter antennas 230 receive the array of waveforms from the MIMO modulator 220 and proceed to transmit them across the channel H.

The plurality of MIMO receiver antennas 240 each receive the waveforms transmitted by the plurality of MIMO transmitter antennas 230 and provide them to the MIMO demodulator 245.

The MIMO demodulator 245 receives the array of received waveforms from the plurality of MIMO transmitter antennas 230, and converts them back into symbols chosen from the constellation of possible symbol values. Over the course of K symbol lengths, the MIMO demodulator 245 will thus create K arrays of length N (where N is the number of receiver antennas 240).

In the embodiment discussed above by way of example, the receiver portion of the system 200 has two receiver antennas 240, and the STC matrix S is transmitted over two symbol lengths (i.e., N=2 and K=2). This means that in this disclosed embodiment, the MIMO demodulator 245 will generate two (2×1) receive symbol arrays y_{A} and y_{B}:

$$\begin{matrix}{y}_{A} = [ \begin{matrix}{y}_{1 A} \\ {y}_{2 A}\end{matrix} ] and & ( 23 ) \\ {y}_{B} = [ \begin{matrix}{y}_{1 B} \\ {y}_{2 B}\end{matrix} ] & ( 24 )\end{matrix}$$

that can conceptually be combined to form a (2×2) receive matrix Y that corresponds to the STC matrix S provided by the STC encoder 215:

$$Y = [ \begin{matrix}{y}_{1 A} & {y}_{1 B} \\ {y}_{2 A} & {y}_{2 B}\end{matrix} ] . \qquad ( 25 )$$

However, because the number of receiver antennas 240 may not be the same as the number of transmitter antennas 230, the size of the receive matrix Y may not be the same as the STC matrix S. In addition, the elements that populate receive matrix Y do not correspond directly to any of the elements in the STC matrix S.

At each symbol period, each of the receiver antennas 240 receives a sum of all of the signals transmitted by the M transmitter antennas 240, as modified by the relevant portion of the channel H, plus a noise element.

For example, in the disclosed example, the signal portions y_{1A}, y_{2A}, and y_{3A} of the symbol arrays y_{A} are determined as follows:

y_{1A}=h₁₁·s_{1A}+h₂₁·s_{2A}+h₃₁·s_{3A}+h₄₁·s_{4A}, (25)

y_{2A}=h₁₂·s_{1A}+h₂₂·s_{2A}+h₃₂·s_{3A}+h₄₂·s_{4A}, and (26)

where h₁₁, h₁₂, h₂₁, h₂₂, h₃₁, h₃₂, h₄₁, and h₄₂ are the elements of the (2×4) channel matrix H that describes the channel between the four transmitter antennas 230 and the two receiver antennas 240, as shown below:

$$H = [ \begin{matrix}{h}_{11} & {h}_{21} & {h}_{31} & {h}_{41} \\ {h}_{12} & {h}_{22} & {h}_{32} & {h}_{42}\end{matrix} ] . \qquad ( 27 )$$

The signal portions y_{1B} and y_{2B} of the symbol array y_{B} can be determined in a similar fashion.

The receive matrix Y can thus be considered the product of the STC matrix S and the channel matrix H, as shown below:

Y=H·S+N, (28)

where N is a noise term.

In the disclosed embodiment, in which M=4 and N=3, this can be shown in more detail by the equation:

$$[ \begin{matrix}{y}_{1 A} & {y}_{1 B} \\ {y}_{2 A} & {y}_{2 B}\end{matrix} ] = [ \begin{matrix}{h}_{11} & {h}_{21} & {h}_{31} & {h}_{41} \\ {h}_{12} & {h}_{22} & {h}_{32} & {h}_{42}\end{matrix} ] \cdot [ \begin{matrix}{s}_{1 A} & {s}_{1 B} \\ {s}_{2 A} & {s}_{2 B} \\ {s}_{3 A} & {s}_{3 B} \\ {s}_{4 A} & {s}_{4 B}\end{matrix} ] + [ \begin{matrix}{n}_{1 A} & {n}_{1 B} \\ {n}_{2 A} & {n}_{2 B}\end{matrix} ] \qquad ( 29 )$$

where n_{1A}, n_{2A}, n_{1B}, and n_{2B}, are noise terms.

The STC decoder 250 takes the receive matrix Y and, based on a knowledge of the STC, extract a final symbol stream f of length J (i.e., a (1×J) array of symbol values) that corresponds to the preprecoded symbol stream p provided to the STC encoder 215, i.e., each element of the final symbol stream f corresponds to a similarly-placed element in the preprecoded symbol stream p.

However, since the channel H is a fading channel, the values of the elements in the final symbol stream f will not be equivalent to their corresponding elements in the preprecoded symbol stream p. They will have experienced some distortion from the transmission channel H.

The preprecoder matrix V may be chosen to minimize a given metric such as bit error rate (BER), packet error rate (PER), etc., to approximate a prescribed or predetermined matrix.

The channel decoder/demodulation circuit 255 then takes the final symbol stream f from the STC decoder 250 and performs any further processing required to generate a receive bit stream that is provided to circuitry in the receiver device. Since the preprecoder matrix V has been chosen to optimize some transmission performance metric (e.g., minimize BER or PER, maximize spectral efficiency or data rate, etc.), the system can extract an accurate copy of the transmit bit stream provided to the data modulator 205 with minimal error.

By using the preprecoder 210, the data symbol stream d is modified into the preprecoded symbol stream p before it is provided to the STC encoder 215, to account for the effect of the channel H, and to reduce the a given error measurement (e.g., BER, PER, or the like). The STC encoder 215 thus operates not directly on the data symbol stream d, but on the preprecoded symbol stream p.

Comparable Circuit/MIMO System

One way to determine the values in the preprecoder V is to model the system 200 without the preprecoder 210 as a simplified comparable circuit, and use that comparable circuit to predict a desired preprecoder V.

As noted above in equations (28) and (29), the received matrix Y is a function of the channel matrix H, the STC matrix S, and a noise matrix N (i.e., Y=H·S+N). But these matrices can also be written out and expanded into multiple algebraic equations relating all of the elements of Y, H, S, and N. Equations (18)-(21) can then be used to replace elements s_{1B}, s_{2B}, s_{3B}, and s_{4B} with in these equations with functions of elements s_{1A}, s_{2A}, s_{3A}, and s_{4A}, and equations (14)-(17) can replace elements s_{1A}, s_{2A}, s_{3A}, and s_{4A} with elements p₁, p₂, p₃, and p₄. The new equations can then be further rearranged and put back into a matrix representation:

$$[ \begin{matrix}{y}_{1} \\ {y}_{2}^{*} \\ {y}_{3} \\ {y}_{4}^{*}\end{matrix} ] = [ \begin{matrix}{h}_{1} & {h}_{2} & {h}_{3} & {h}_{4} \\ {h}_{2}^{*} & - {h}_{1}^{*} & {h}_{4}^{*} & - {h}_{3}^{*} \\ {h}_{5} & {h}_{6} & {h}_{7} & {h}_{8} \\ {h}_{6}^{*} & - {h}_{5}^{*} & {h}_{8}^{*} & - {h}_{7}^{*}\end{matrix} ] \cdot [ \begin{matrix}{p}_{1} \\ {p}_{2} \\ {p}_{3} \\ {p}_{4}\end{matrix} ] + [ \begin{matrix}{n}_{1} \\ {n}_{2} \\ {n}_{3} \\ {n}_{4}\end{matrix} ] . \qquad ( 30 )$$

which can be simplified into:

\tilde{y}=\tilde{H}·p+n, (31)

where \tilde{y} is a comparable received array, \tilde{H} is a comparable channel matrix, p is the preprecoded symbol vector of equations (4)-(9), and n is a noise array. And since equation (4) shows that p=V·d, this can be further written out as:

\tilde{y}=\tilde{H}·V·d+n (32)

This effectively allows the system 200 of FIG. 2 to be modeled as a simplified comparable system in which the data symbol vector d, is modified by the preprecoding vector V, and is transmitted over the a comparable channel matrix \tilde{H} to generate a comparable received array.

FIG. 3 is a block diagram of a comparable circuit of the circuit of FIG. 2. As noted above, this allows for a more simplified analysis of the operation of the MIMO transmitter/receiver pair 200 in FIG. 2. As shown in FIG. 3, the comparable circuit 300 includes a preprecoder 310, a MIMO modulator 320, a transmitter antenna array 330, a receiver antenna array 350, and a MIMO demodulator 360.

The preprecoder 310 receives an array of data symbols d, and applies the preprecoder (i.e., the preprecoding matrix) to them to generate an array of preprecoded symbols p for transmission. The MIMO modulator 320 then converts the preprecoded symbols p into proper signals for transmission.

The transmitter antenna array 330 transmits the MIMO encoded symbols p over the comparable channel \tilde{H}. This comparable channel \tilde{H} incorporates the effect of a space time code.

In the comparable circuit, the receiver antenna array 350 receives the encoded array as the comparable receive signal \tilde{y}, as described above with respect to equations (30)-(32).

The demodulator 360 accepts the comparable receive signal \tilde{y} and converts it into a final array of symbols f, which is then converted in later processing back into a bit stream.

As shown in equations (30)-(32), the fact that the preprecoding takes place prior to STC encoding makes it easy to write a comparable circuit that shows the preprecoding matrix V in terms of values that are relatively easy to measure or otherwise determine (i.e., \tilde{y}, d, and \tilde{H}). As a result, the determination of the preprecoding matrix V can be made much simpler as compared to a system that used a precoder subsequent to STC encoding.

In particular, a multiple-input/multiple-output transmitter is provided, comprising: a symbol modulator configured to receive B data bits and to modulate the B data bits into J data symbols chosen from a set symbol constellation; a preprecoding circuit configured to convert the J data symbols into L preprecoded symbols based on a preprecoder function; and a space-time code encoder configured to map the L preprecoded symbols into M symbol streams, each containing K encoded symbols based on a space-time code, wherein B, J, K, L, and M are all integers.

The multiple-input/multiple-output transmitter may further comprise: a radio frequency modulator for modulating the M symbol streams into M radio frequency signal streams; and M antenna elements connected to the space-time code encoder for transmitting the M signal streams as M transmitted signals.

The symbol modulator may employ one of a binary-phase shift keying operation, a quadrature phase shift keying operation, and a quadrature amplitude modulation operation.

The preprecoder function may be defined by a (J×L) matrix of preprecoding values. The space-time code may be defined by an (M×K) matrix whose elements are determined based on the L preprecoded symbols.

In this method J may be equal to L, B may be between 1 and 8, inclusive, J may be between 1 and 64, inclusive, L may be greater than zero, M may be between 1 and 8, inclusive and K may be between 1 and 8, inclusive.

The multiple-input/multiple-output transmitter may be implemented using an integrated circuit.

Selection of the Preprecoder

By examining equation (32), it is possible for any given system to determine a desired value for the precoding matrix V to optimize one or more transmission performance metrics.

In any transmission system, the STC used by the MIMO encoder 320 will be known prior to operation. This means that the process of mapping the array of preprecoded symbols p into the STC matrix S, as well as the process of mapping the received matrix Y onto the final array of symbols f will also be known. The channel can be measured, allowing a system to determine H by observation. And the comparable channel \tilde{H} can be deduced from H.

Based on this information a comparable circuit can be generated (using a process similar to the one described above with respect to FIG. 3); and based on the comparable circuit, the preprecoding matrix V can be obtained, derived, or chosen to minimize a specified metric such as BER, PER etc. For example, the preprecoding matrix V can be chosen to resemble a pre-specified matrix or a matrix based on the channel such as the right singular matrix of the comparable channel \tilde{H}. However, alternate methods of determining the elements in the preprecoding matrix V will be readily apparent to one skilled in the art.

Method of Operation

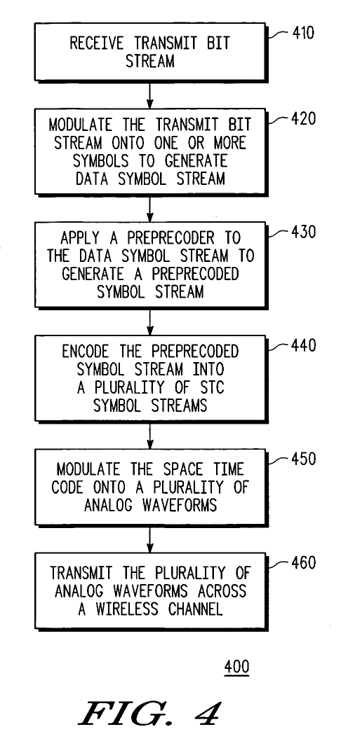

FIG. 4 is a flow chart showing a method of operating a MIMO transmitter according to disclosed embodiments. As shown in FIG. 4, the operation 400 begins when the transmitter receives a stream of data bits for transmission. (410).

The transmitter then modulates the data bit stream onto one or more symbols chosen from an available constellation of symbols to create a data symbol stream. (420) This modulation operation could involve modulating a single data bit onto each symbol (e.g., using BPSK modulation) or modulating multiple data bits onto each symbol (e.g., using QPSK or N-QAM).

A preprecoder is then applied to the data symbol stream to convert the data symbol stream into a preprecoded symbol stream. (430) In one embodiment the preprecoder is a (J×J) preprecoding matrix V that converts a J-symbol portion d of the data symbol stream into a J-symbol portion p of the preprecoded symbol stream.

The preprecoded symbol stream is then used to generate a plurality of space-time code (STC) symbol streams. (440) This is accomplished by mapping a set of symbols from the preprecoded symbol stream (i.e., J symbols) into a matrix of STC symbol values based in a set STC. The rows of this STC matrix are then output as the separate STC symbol streams. The number of rows in the STC matrix reflects the number of transmission antennas used by the transmitter, and the number of columns in the STC matrix represents the length of the transmission from each of the antennas for each set of preprecoded data sent, as is discussed above.

Each of the STC symbol streams is then modulated into a plurality of analog waveforms suitable for transmission (450), which are then transmitted across a wireless channel using some kind of transmission element (e.g., an antenna array). (460)

The individual processes performed in the operation 400 of FIG. 4 can be implemented in hardware or software in various embodiments. In some embodiments it is even possible that some of the disclosed processes could be performed in software, and some in hardware.

In particular, a method for processing signals in a multiple-input/multiple-output transmitter, comprising: receiving a stream of B data bits; modulating the B data bits into J data symbols chosen from a set symbol constellation; converting the J data symbols into L preprecoded symbols based on a preprecoder function; encoding the L preprecoded symbols into M symbol streams, each having K encoded symbols, based on a space-time code; and providing the M symbol streams on one or more output lines. In this method, B, J, K, L, and M are integers.

The number of output lines may or may not correspond to the number of symbol streams. In one embodiment there are M output lines, allowing each symbol stream to pass on its own dedicated output line. But other numbers of output lines are possible. If more than M output lines are used, elements from the M symbol streams can be broken up to pass more quickly in parallel. If fewer than M output lines are used, then some of the M symbol streams must pass their data on the same output line. In the case where only one output line is provided, all of the symbol streams must pass along the same symbol line in series.

The method may further comprise: modulating the M symbol streams into M radio frequency signal streams; and transmitting the M radio frequency signal streams across a wireless medium.

The process of modulating the B data bits into J data symbols may employ one of a bi-phase shift keying operation, a quadrature phase shift keying operation, and a quadrature amplitude modulation operation.

The preprecoder function may be one of a linear function defined by a (J×L) matrix of preprecoding values, and a non-linear function of the data to be transmitted. The space-time code may be defined by an (M×K) matrix whose elements are a function of the L preprecoded symbols.

Each of the K encoded symbols on each of the M symbol streams may be one of the L preprecoded symbols, or a modified symbol obtained by performing one or more symbol manipulations on one of the L preprecoded symbols. The one or more symbol manipulations may include one or both of linear operations or nonlinear operations. The one or more symbol manipulations may also include at least one of generating a complex conjugate of one of the L preprecoded symbols or inverting one of the L preprecoded symbols.

In some embodiments of this method, B may be between 1 and 8, inclusive, J may be between 1 and 64, inclusive, L may be greater than zero, M may be between 1 and 8, inclusive and K may be between 1 and 8, inclusive. However, these values are by way of example only. Alternate values for B, J, L, M, and K may be used as desired in alternate embodiments.

The method may be implemented using an integrated circuit.

A method is also provided for processing signals in a multiple-input/multiple-output transmitter, comprising: receiving a stream of J data symbols chosen from a set symbol constellation; generating L preprecoded symbols by multiplying an array of the J data symbols by a (J×L) preprecoding matrix containing J times L preprecoding values; generating M symbol streams, each containing K encoded symbols based on the L preprecoded symbols; wherein J, K, L, and M are all integers, and wherein J is less than or equal to the product of K and M.

Each of the K encoded symbols on each of the M symbol streams may be one of the L preprecoded symbols, or a modified symbol obtained by performing one or more symbol manipulations on one of the J preprecoded symbols. The one or more symbol manipulations may include at least one of linear or non-linear operations. The one or more symbol manipulations may include at least one of generating a complex conjugate of one of the L preprecoded symbols and inverting one of the L preprecoded symbols.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method for processing signals in a multiple-input/multiple-output transmitter, comprising:
receiving a stream of B data bits;
modulating the B data bits into J data symbols chosen from a set symbol constellation;
converting the J data symbols into L preprecoded symbols based on a preprecoder function;
encoding the L preprecoded symbols into M symbol streams, each having K encoded symbols, based on a space-time code; and
providing the M symbol streams on one or more output lines,
wherein B, J, K, L, and M are integers.

2. The method of claim 1, further comprising:
modulating the M symbol streams into M radio frequency signal streams; and
transmitting the M radio frequency signal streams across a wireless medium.

3. The method of claim 1, wherein the process of modulating the B data bits into J data symbols employs one of a bi-phase shift keying operation, a quadrature phase shift keying operation, and a quadrature amplitude modulation operation.

4. The method of claim 1, wherein the preprecoder function is one of a linear function defined by a (J×L) matrix of preprecoding values, and a non-linear function of the data to be transmitted.

5. The method of claim 1, wherein the space-time code is defined by an (M×K) matrix whose elements are a function of the L preprecoded symbols.

6. The method of claim 1, wherein each of the K encoded symbols on each of the M symbol streams is one of the L preprecoded symbols, or a modified symbol obtained by performing one or more symbol manipulations on one of the L preprecoded symbols.

7. The method of claim 6, wherein the one or more symbol manipulations comprise one or both of linear operations or nonlinear operations.

8. The method of claim 6, wherein the one or more symbol manipulations comprise at least one of generating a complex conjugate of one of the L preprecoded symbols or inverting one of the L preprecoded symbols.

9. The method of claim 1, wherein the method is implemented using an integrated circuit.

10. A method for processing signals in a multiple-input/multiple-output transmitter, comprising:
receiving a stream of J data symbols chosen from a set symbol constellation;
generating L preprecoded symbols by multiplying an array of the J data symbols by a (J×L) preprecoding matrix containing J times L preprecoding values;
generating M symbol streams, each containing K encoded symbols based on the L preprecoded symbols,
wherein J, K, L, and M are all integers, and
wherein J is less than or equal to the product of K and M.

11. The method of claim 10, wherein each of the K encoded symbols on each of the M symbol streams is one of: a) the L preprecoded symbols, or b) a modified symbol obtained by performing one or more symbol manipulations on one of the J preprecoded symbols.

12. The method of claim 11, wherein the one or more symbol manipulations comprise one or both of linear operations and non-linear operations.

13. The method of claim 11, wherein the one or more symbol manipulations include at least one of generating a complex conjugate of one of the L preprecoded symbols and inverting one of the L preprecoded symbols.

14. A multiple-input/multiple-output transmitter, comprising:
a symbol modulator configured to receive B data bits and to modulate the B data bits into J data symbols chosen from a set symbol constellation;
a preprecoding circuit configured to convert the J data symbols into L preprecoded symbols based on a preprecoder function; and
a space-time code encoder configured to map the L preprecoded symbols into M symbol streams, each containing K encoded symbols based on a space-time code,
wherein B, J, K, L, and M are all integers.

15. The multiple-input/multiple-output transmitter of claim 14, further comprising:
a radio frequency modulator for modulating the M symbol streams into M radio frequency signal streams; and
M antenna elements connected to the space-time code encoder for transmitting the M signal streams as M transmitted signals.

16. The multiple-input/multiple-output transmitter of claim 14, wherein the symbol modulator employs one of a binary-phase shift keying operation, a quadrature phase shift keying operation, and a quadrature amplitude modulation operation.

17. The multiple-input/multiple-output transmitter of claim 14, wherein the preprecoder function is defined by a (J×L) matrix of preprecoding values.

18. The multiple-input/multiple-output transmitter of claim 14, wherein the space-time code is defined by an (M×K) matrix whose elements are determined based on the L preprecoded symbols.

19. The multiple-input/multiple-output transmitter of claim 14, wherein J is equal to L.

20. The multiple-input/multiple-output transmitter of claim 14, wherein the transmitter is implemented using an integrated circuit.
